(19) United States
(12) Patent Application Publication
(10) Pub. No.: US 2002/0075612 A1
(43) Pub. Date: Jun. 20, 2002

(54) High voltage transformer with over voltage protection, and method for over voltage protection

(76) Inventor: Marinus Johannes Josephus Klaassen, Eindhoven (NL)

Correspondence Address: Corporate Patent Counsel, U.S. Philips Corporation, 580 White Plains Road, Tarrytown, NY, 10591, US

(21) Appl. No.: 10/012,019

(22) Filed: Dec. 5, 2001

(30) Foreign Application Priority Data
Dec. 14, 2000 (EP) 00204513.6

(51) Int. Cl. H02H 7/04

(52) U.S. Cl. 361/35

(57) ABSTRACT

The present invention relates to a high voltage transformer (e.g. for CRT display units) with an over voltage protection (OVP), comprising a primary, low voltage winding, a secondary, high voltage winding, and an over protection circuit, arranged to cut off the transformer when the voltage in an auxiliary winding exceeds a predefined level. According to the invention the auxiliary winding is coupled to the secondary winding and isolated from the secondary winding by at least one layer of insulating foil. The invention improves the load variation of the relationship between the voltage on the secondary side and the voltage in the auxiliary winding, reducing it to less than 1 kV over the normal load range.

The present invention relates to a high voltage transformer with an over voltage protection (OVP), comprising a primary, low voltage winding, a secondary, high voltage winding and an over protection circuit, arranged to cut off the transformer when the voltage in an auxiliary winding exceeds a predefined level. More specifically, the invention relates to the type of transformers in high voltage generators common in CRT display units. The invention also relates to a method for over voltage protection.

In many types of electrical equipment, voltage transformers are used to acquire high voltage in the order of kV. For example, in a CRT, the picture tube requires a voltage in the neighborhood of 27 kV. A conventional high voltage transformer has a primary —low voltage—side, and a secondary—high voltage—side, transforming the voltage from a voltage source into the desired high voltage.

In order to fulfill the X-ray emission requirements (for example concerning the radiation from a computer monitor), an over voltage protection (OVP) circuitry is normally implemented, securing that the voltage in the equipment does not exceed a predetermined level.

To simply measure the output voltage from the transformer can not be done in a cost efficient way, due to the high voltage involved, and therefore the OVP comprises an auxiliary sensor winding, in which a current proportional to the output voltage is induced. This auxiliary winding is provided on the primary, low voltage side, and the OVP is arranged to cut of the transformer when the signal from the auxiliary winding exceeds a predetermined level.

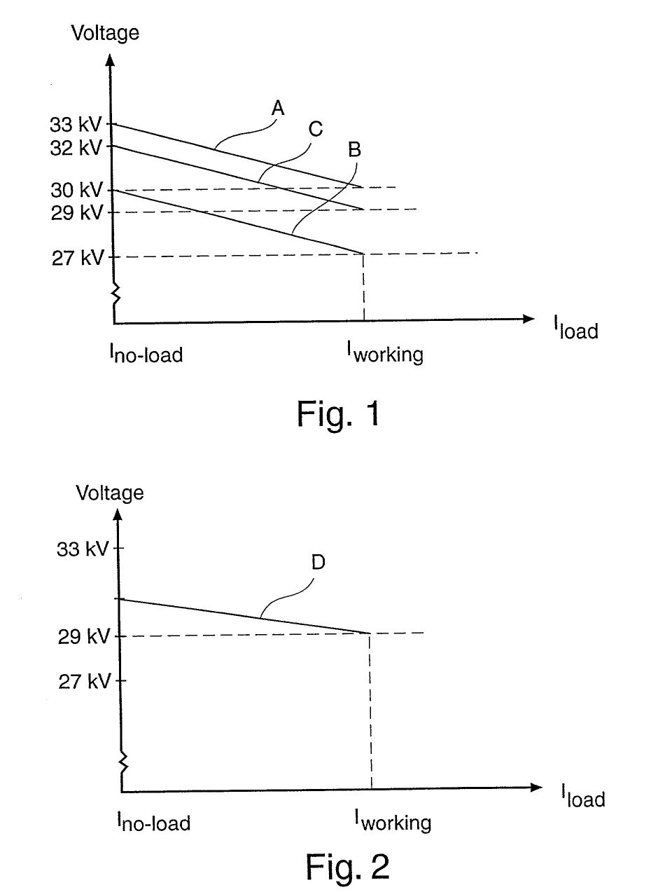

However, the relationship between the voltage on the secondary side and the voltage in the sensor winding varies with the load, as shown in FIG. 1. In a picture tube application, the variation is approximately 3 kV over the considered load range. Unfortunately, this is very close to the difference between the normal working voltage for a CRT of about 27 kV, and the desired OVP cut-off voltage of about 30 kV. Thus, if the OVP is calibrated to activate at 30 kV when the tube is in working condition (I_{working}), the voltage can reach as high as 33 kV in the no-load condition (I_{no-load}) (curve A in FIG. 1). This level is considered too high. If, on the other hand, the OVP is calibrated to activate at 30 kV in the no-load condition, the OVP may accidentally cut the current at 27 kV during normal working conditions (curve B in FIG. 1). In practice, the solution has been to compromise, resulting in a cut-off during working conditions at 29 kV, while accepting a 32 kV voltage during no-load conditions (curve C in FIG. 1).

The problem can be solved with compensation circuitry, adapted to adjust the slope of the sensor/secondary side relationship, but this is expensive to implement with the high tolerance that is required.

The object of the present invention is to overcome the above mentioned problems, and to provide a high voltage transformer with an OVP sensor on the secondary side.

This and other objects are accomplished with a high voltage transformer of the type mentioned by way of introduction, characterized in that said auxiliary winding is coupled to the secondary winding and isolated from the secondary winding by at least one layer of insulating foil.

With this transformer, the relationship between the output voltage and the sensor voltage is much improved, as illustrated in FIG. 2. The difference over the considered load range can be reduced to less than 1 kV, making it possible to implement the OVP cut-off level over the entire load range, without risking a premature cut-off. During testing, a voltage difference of 600 V has been accomplished over the desired load range (curve D in FIG. 2).

According to a first embodiment of the invention, the secondary winding is formed with a plurality of coaxial layers, each layer comprising a winding layer and an insulation layer. In this type of winding, it is especially advantageous to arrange the auxiliary winding coupled to the secondary winding. The insulation layers can each comprise several turns of insulating foil, making the winding easy to manufacture. The auxiliary winding is in this case preferably arranged radially inside the innermost winding layer of the secondary winding. This design makes it possible to maintain a smooth surface of the secondary winding. As the insulation layers are already present in the design of the secondary winding, the insulation between the secondary winding and the auxiliary winding is easily accomplished.

According to a second embodiment, the secondary winding is formed with a plurality of axially spaced winding sections, each containing a plurality of winding turns. This type of winding is common in many high voltage applications. The auxiliary winding is in this case preferably arranged radially inside the winding turns in one of said sections.

These and other aspects of the invention will be apparent from the preferred embodiments more clearly described with reference to the appended drawings.

FIG. 1 is a graph of the voltage in the sensor winding according to prior art.

FIG. 2 is a graph of the voltage in the sensor winding according to the invention.

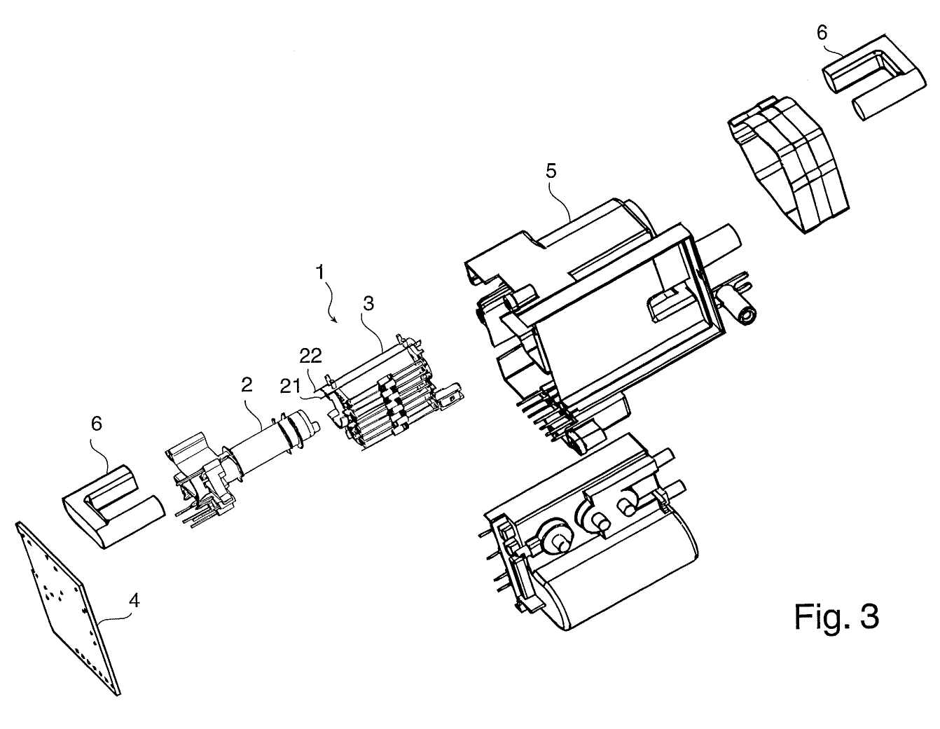

FIG. 3 is an exploded view of a high voltage transformer.

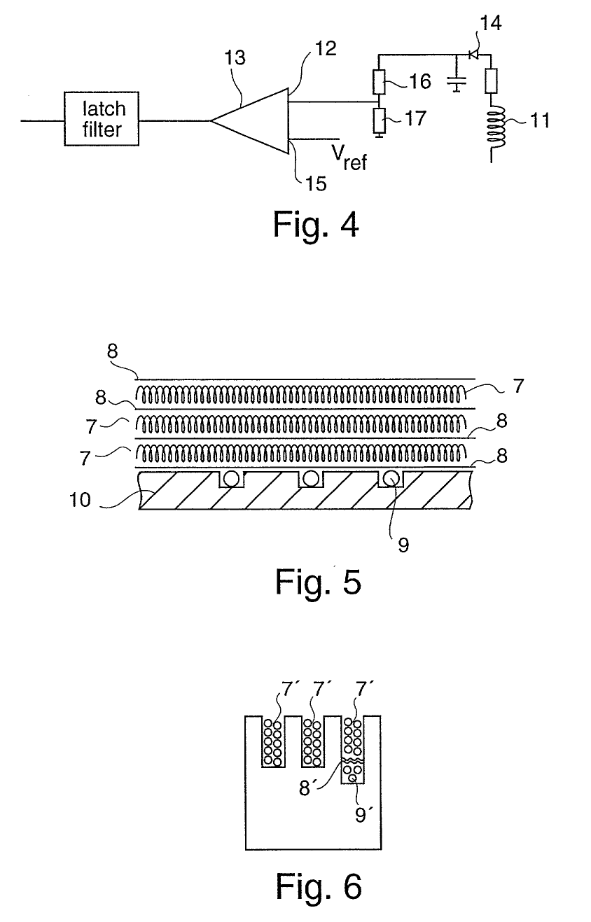

FIG. 4 is a schematic drawing of an OVP circuit in the transformer in FIG. 3.

FIG. 5 is a perspective view of the sensor winding according to the invention, arranged in the transformer in FIG. 3.

FIG. 6 is a perspective view of a sensor winding according to the invention, arranged in a different type of coil.

In FIG. 3, a high voltage transformer 1 is shown in exploded view. The transformer is adapted for transforming a voltage into high voltage (approx. 27 kV), and comprises a primary winding 2, a secondary winding 3, and circuitry 4 including an OVP circuit. The primary winding 2 and the secondary winding 3 are arranged coaxially in a housing 5, with a ferrite core 6 arranged in the center.

The secondary winding 3 is formed by several layers of windings with about 600 turns of copper wire each. In between the winding layers are arranged isolation layers comprising three layers of MAILAR foil (each foil layer having a thickness of 75μ). For an illustration, see FIG. 5, described below. In total, the secondary winding comprises eight winding layers, each layer accomplishing a voltage induction of 3-4 kV, resulting in 27 kV secondary side voltage.

A simple form of OVP circuit is illustrated in FIG. 4. A sensor winding 11 is connected to one terminal 12 of a comparator 13 via a diode 14. The other terminal 15 of the comparator 13 is connected to a reference voltage V_{ref}, normally chosen in the range 2-3 volts suitable for conventional comparators. The voltage from the sensor winding is divided using two resistors 16, 17, the resistors being adapted to ensure that the voltage over the first terminal 12 of the comparator 13 exceeds the voltage V_{ref} on the second terminal when the voltage over the sensor winding 11 passes a predefined threshold value. Normally, the sensor winding is adapted to generate a voltage of around 20 V.

With reference to FIG. 5, a section of the secondary winding 3 is shown, including three of the winding layers 7, with intermediate isolation layers 8. A sensor winding 11 is arranged as an auxiliary winding 9 inside the innermost winding layer 7 of the secondary winding, separated from this winding layer by an additional insulation layer 8. The auxiliary winding 9 preferably consists of three turns, resulting in approx. 20 V of output voltage during normal working conditions.

The auxiliary winding 9 can of course be arranged between any other winding layers 7 in the secondary winding 3, care being taken to insulate the auxiliary winding 9 from the secondary winding layers 7. However, an advantage of arranging the auxiliary winding 9 inside the innermost winding, is that the auxiliary winding 9 can be at least partly embedded in the coilformer 10 of the secondary winding (see FIG. 5). The coilformer 10, which is normally made of a plastic material such as Noryl, is very suitable for this embedding function.

Returning to FIG. 3, reference numeral 21 denotes a lead connected to the inner end of the auxiliary winding hidden inside the secondary winding 3. The purpose of this pin is to avoid the need of a return line from the end of the auxiliary winding inside the secondary winding. Such a return line would disturb the coupling, and cause irregularities is the surface onto which the secondary winding is wound.

Further, reference numeral 22 denotes a lead connected to the outer end of the auxiliary winding, and it is thus these two leads 21, 22 that present the voltage of the sensor winding 11. As the sensor winding according to the invention is arranged in the secondary winding 3, an electrical connection between the secondary winding 3 and the circuitry 4 is necessary. In the illustrated example, the leads 21, 22 are simply physically connected to the circuitry, resulting in a rigid construction of the transformer. The primary winding 2 and the circuitry 4 cannot be dislocated from the secondary winding 3 when the leads 21, 22 are fastened to the circuitry.

Another embodiment of the invention relates to a transformer with a more conventional coil, where the secondary winding layers are arranged in axially separated sectors (see FIG. 6). In this case, the auxiliary winding 9′ according to the invention can preferably be arranged radially inside one of the secondary winding layers 7′, isolated by an insulation layer 8′, as illustrated in FIG. 6.

Further embodiments are also possible within the scope of the invention, which is not limited by the above description. For example, other designs of secondary windings are possible, still allowing for an arrangement of an auxiliary winding separated with an insulation layer. Thereby the advantages of the present invention can be obtained.

1. High voltage transformer with an over voltage protection (OVP), comprising
a primary, low voltage winding,
a secondary, high voltage winding,
an over protection circuit, arranged to cut off the transformer when the voltage in an auxiliary winding exceeds a predefined level,
characterized in that said auxiliary winding is coupled to the secondary winding and isolated from the secondary winding by at least one layer of insulating foil.

2. High voltage transformer according to claim 1, wherein said secondary winding is formed with a plurality of coaxial layers, each layer comprising a winding layer and an insulation layer.

3. High voltage transformer according to claim 2, wherein each insulation layer comprises at least one layer of insulating foil.

4. High voltage transformer according to claim 2 or 3, wherein said auxiliary winding is arranged radially inside the innermost winding layer of the secondary winding.

5. High voltage transformer according to claim 1, wherein said secondary winding is formed with a plurality of axially spaced winding sections, each containing a plurality of winding turns.

6. High voltage transformer according to claim 5, wherein said auxiliary winding is arranged radially inside said winding turns in one of said winding sections.

7. Method for over voltage protection (OVP) of a high voltage transformer comprising a primary, low voltage winding, a secondary, high voltage winding, an over protection circuit, arranged to cut off the transformer when the voltage in an auxiliary winding exceeds a predefined level, characterized in coupling said auxiliary winding to the secondary, high voltage winding, and isolating said auxiliary winding from the secondary winding with at least one layer of insulating foil.
